(19) United States
(12) Patent Application Publication
(10) Pub. No.: US 2014/0365303 A1
(43) Pub. Date: Dec. 11, 2014

(54) INFORMATION FILTERING AT USER DEVICES

(71) Applicant: Microsoft Corporation, Redmond, WA (US)

(72) Inventor: Ram Vaithilingam, Issaquah, WA (US)

(21) Appl. No.: 13/914,624

(22) Filed: Jun. 11, 2013

(51) Int. Cl. G06Q 30/02

(52) U.S. Cl. CPC G06Q 30/0256
USPC 705/14.54

(57) ABSTRACT

Various techniques for selecting electronic messages based on user data residing on user devices are described herein. In one embodiment, a method performed by a computing system includes receiving a search query via an input device of the computing system, transmitting the received search query to a server, and receiving a set of electronic messages from the server in response to the transmitted search query. The method also includes selecting a subset of the received electronic messages at the computing system based on user data residing on the computing system. The selected subset of electronic messages are then displayed via an output device of the computing system.

### BACKGROUND

Online advertising can deliver advertisements selected based on content provided to users. For instance, when a user submits a query to a search engine, the user may be presented with search results as well as advertisements for products and/or services related to the query. When the user clicks on any of the displayed advertisements, the user may be redirected to web pages based on web addresses embedded in the advertisements.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Computer systems (e.g., ad servers) can select electronic messages (e.g., advertisements) based on user information received from user devices. The user information can include, for example, keywords associated with queries submitted to search engines as well as geographic locations, user profile information (e.g., age, gender, etc.), and/or other additional information associated with the queries. The user information, however, may be limited due to privacy concerns or a lack of availability. As a result, computer systems may not select and serve sufficiently relevant, useful, and/or suitable electronic messages in response to the received user information.

Several embodiments of the present technology can address at least some of the foregoing difficulties by filtering the electronic messages received from a server and selecting a subset of the electronic messages at a user device based on user data residing on the user device, without transmitting the user data to the computer systems. For example, in one embodiment, the user data can include a signal indicating a number of people present at a location proximate the user device. Based on such information, the user device can select a subset of electronic messages intended for a general audience from the received electronic messages if the number of people is more than one. Otherwise, the user device may select another subset of electronic messages specifically intended for the user. In other examples, the user device may select the subset of the electronic messages based on at least one of calendar data, contact data, task data, user activity data, or other suitable user data on the user device.

In another embodiment, the user device can also generate one or more abstract indications based on the user data without compromising user privacy. For example, the abstract indications may include a signal representing that the user is currently playing video games, chatting online, and/or engaged in other activities without any user identifying information. The user device can then transmit the abstract indications along with a query to the server. Based on the query, abstract indications, and/or other suitable information, the server can select and transmit sufficiently relevant, useful, and/or suitable electronic messages to the user device. The user device can then display the received electronic messages to the user with or without filtering at the user device.

### BRIEF DESCRIPTION OF THE DRAWINGS

FIG. 1 is a schematic block diagram illustrating a computer framework for providing electronic messages to user devices in accordance with embodiments of the present technology.

FIG. 2 is a block diagram showing software modules suitable for the device filter of FIG. 1 in accordance with embodiments of the present technology.

FIG. 3 is a flow diagram illustrating a process of filtering electronic messages on a computing device in accordance with embodiments of the present technology.

FIG. 4 is a flow diagram illustrating a process of providing electronic messages in accordance with embodiments of the present technology.

FIG. 5 is a computing device suitable for certain components of the computer framework in FIG. 1.

### DETAILED DESCRIPTION

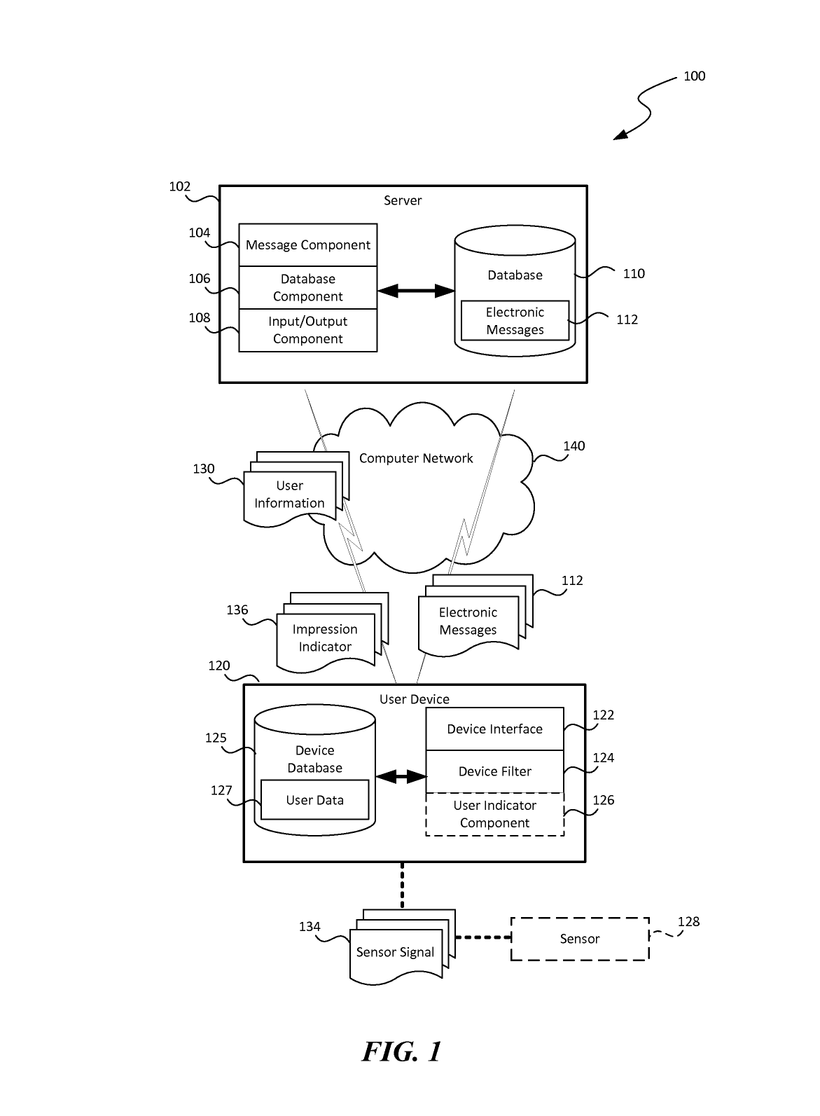

Various embodiments of systems, devices, components, modules, routines, and processes for selecting electronic messages based on user data residing on user devices are described below. In the following description, example software codes, values, and other specific details are included to provide a thorough understanding of various embodiments of the present technology. A person skilled in the relevant art will also understand that the technology may have additional embodiments. The technology may also be practiced without several of the details of the embodiments described below with reference to FIGS. 1-5.

As used herein, the term “device” generally refers an apparatus made or adapted for one or more tasks. For example, a device can include one or more sensors, displays, touchscreens, processors, memories, and/or other suitable input, output, processing, or storage component. Also used herein, the term an “electronic message” generally refers to an item of electronic communication. The communication can be directed to information that is provided to a user based on assessments of user activities, user locations, developments in information that the user has expressed interest in or are consistent with the user's profile, and other suitable user information. Examples of electronic messages can include a suggestion to install a software component (e.g., an add-in), a civil emergency message, a traffic information message, a weather information message, a financial information message, a news bulletin message, an electronic advertisement, other suitable types of message, or a combination thereof. In certain embodiments, an electronic message may include a body with at least one of a title, a description, an image, a map, a contact (e.g., a phone number or a web link), or other suitable information to be displayed on a user device. In other embodiments, an electronic message may also include appended meta data that include, for example, a keyword set, a location identifier, intended demographics, or other information.

User information that remote computer systems (e.g., ad servers) can identify and/or infer may be limited because such information is either unavailable due to privacy concerns or is too burdensome to process and transmit. As a result, remote computer systems may not select and serve sufficiently relevant, useful, and/or suitable data to users. Several embodiments of the present technology include techniques for filtering received electronic messages and selecting a subset of the electronic messages at a user device based on user data residing in the user device. The set of electronic messages may be received from remote computer systems or other suitable sources. The user data may include additional information of user preferences, user activity, user profiles, and/or other suitable information. Based on the user data, the user device can select and output a subset of the electronic messages that are more relevant, useful, and/or suitable than other received electronic messages. Also, by not transmitting the user data, user privacy may be protected and processing and/or transmission capacity at the user device may be conserved.

FIG. 1 is a schematic block diagram illustrating a computer framework 100 for providing electronic messages to user devices in accordance with embodiments of the present technology. As shown in FIG. 1, the computer framework 100 includes a server 102 operatively coupled to a user device 120 via a computer network 140. The computer network 140 can be the Internet, an intranet, a wide area network, a virtual private network, and/or other suitable networks. Though particular components are shown in FIG. 1, in other embodiments, the computer framework 100 can also include additional and/or different servers, user devices, communication devices, or other suitable components.

The server 102 can be configured to select and provide electronic messages 112 to the user device 120 based on user information 130. In one embodiment, the user information 130 can include a search query and/or additional information inferred from the search query. For example, the additional information may include a geographic location inferred by examining an IP address from which the search query originated. In another example, the additional information can also include profile information (e.g., age, gender, etc.) of a user associated with the search query inferred by, for example, tracking user login information. In further examples, the additional information can include prior search histories, browser histories, and/or other usage information. In other embodiments, the user information 130 can also include one or more abstract indications representing gaming activity information, opening/closing of applications, download histories, and/or other suitable activity information on the user device 120, as described in more detail below.

As shown in FIG. 1, the server 102 can include a message component 104, a database component 106, an input/output component 108, and an database 110 operatively coupled to one another. Even though the server 102 is shown as a single computing unit in FIG. 1, in certain embodiments, the server 102 can include a plurality of sub-servers. In other embodiments, the server 102 may also include an indexing component, maintenance component, and/or other suitable hardware or software components.

The message component 104 can be configured to select a set of electronic messages 112 from the database 110 based on the received user information 130. For example, in one embodiment, the message component 104 is configured to select a set of electronic messages based on at least one of the following:
a search query from the user device 120 and inferred information related to the search query;
a browser history on the user device 120; or
a user gaming history on the user device 120.
   In other embodiments, the message component 104 can be configured to select a set of electronic messages that include advertisements based on bid prices associated with individual advertisements and/or other suitable information, as described in more detail below.

In certain embodiments, the message component 104 can also be configured to append meta data to the selected set of electronic messages 112. For example, in one embodiment, the message component 104 can append meta data that include, for example, a keyword set, a location identifier, or other information associated with products and/or services. In other embodiments, the message component 104 can also append meta data that include a set of conditional bid prices. For example, the appended meta data can include a first bid price if the electronic message is displayed to fewer than a threshold number of people, and a second bid price if the electronic message is displayed to equal or more than the threshold number of people. In further embodiments, the selected set of electronic messages 112 may include previously appended meta data, and the message component 104 may not append any additional meta data to the selected set of electronic messages 112.

The database component 106 is configured to organize records, including the electronic messages 112, and facilitates storing and retrieving of these records to and from the database 110. Any type of database organization may be utilized, including a flat file system, hierarchical database, relational database, or distributed database. The input/output component 108 is configured to accept incoming communication, such as the user information 130, and communicate the accepted information to other components for further processing. The input/output component 108 is also configured to transmit outgoing communication, such as the selected set of electronic messages 112, to the user device 120.

The user device 120 can include a desktop, a laptop, a tablet, a smartphone, a gaming console, and/or other suitable types of computing device. As shown in FIG. 1, the user device 120 can include a device interface 122, a device filter 124, and a device database 125 operatively coupled to one another. The device interface 122 can be configured to accept user input as well as provide output to a user via a touch screen, a television set, and/or other suitable display (not shown). In one embodiment, the device interface 122 can include a web browser-based interface (e.g., a web page). In other embodiments, the device interface 122 can include an application-based interface, a text interface, or other suitable types of interface.

The device filter 124 can be configured to filter the set of electronic messages 112 received from the server 102 and select a subset of electronic messages 112 based on user data 127 stored in the device database 125. The selected subset of electronic messages 112 can then be output via the device interface 122. Such output is referred to herein as an “impression.” The device filter 124 can also be configured to transmit an impression indicator 136 to the server 102 identifying the subset of electronic messages 112 output via the device interface 122.

In certain embodiments, the user data 127 can include data representing information regarding user preferences, user activity, user profiles, and/or other suitable information. For example, in one embodiment, the user data 127 can include at least one of calendar data (e.g., appointments, meetings, etc.), contact data (e.g., contact names, contact addresses, etc.), task data (e.g., task types, due dates, etc.), or user activity data (e.g., browsing histories, video viewing histories, etc.).

In another embodiment, the user device 120 may include or be operatively coupled to a sensor 128, and the user data 127 can also include sensor data received and/or derived from a sensor signal 134. The sensor 128 can include at least one of a motion sensor, an infrared sensor (e.g., a passive infrared sensor), a proximity sensor, an accelerometer, an ambient light sensor, a moisture sensor, a gyroscope, a camera, a pressure sensor, a temperature sensor, a microphone, or other suitable types of sensing element. In one embodiment, the sensor 128 may be integrated into the user device 120. In other embodiments, the sensor 128 may be separated from but operatively coupled to the user device 120. In further embodiments, the sensor 128 may be omitted.

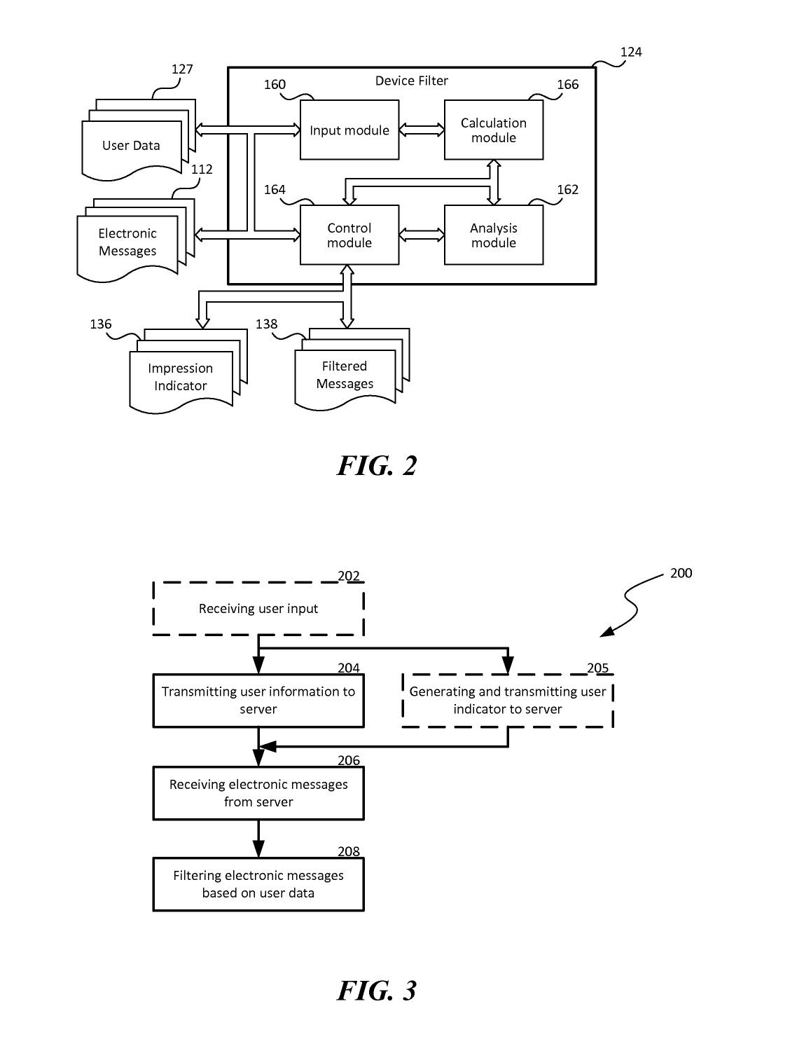

In certain embodiments, the user device 120 can be configured to derive a variety of data from the sensor signal 134 from the optional sensor 128. For example, in one embodiment, the sensor 128 can include a passive infrared sensor. Based on signals collected from the passive infrared sensor, the user device 120 may generate the user data 127 that indicate a number of people present in an audience proximate the user device 120. In another example, the sensor 128 can include a gyroscope. Based on signals collected from the gyroscope, the user device 120 can generate the user data 127 that indicate at least one of a direction or speed of the user device 120. Based on the various user data 127, the device filter 124 can filter the set of electronic messages 112 received from the server 102 and select a subset of electronic messages 112 based on the user data 127, as described in more detail below with reference to FIG. 2.

In certain embodiments, the user device 120 can include an optional abstract indication component 126 that is configured to generate certain user information 130 based on the user data 127 without compromising user privacy. For example, the optional abstract indication component 126 may be configured to conceptualize, generalize, categorize, and/or otherwise extract abstract indications from the user data 127. The abstract indications can include a signal representing at least one of a user activity, (e.g., casual gaming, video chatting, etc.), a user preference (e.g., a geographic area preference), a user profile (e.g., a direction of travel), and/or other information. The abstract indications may not include user names, contact information, aliases, and/or other identifying and/or private information. As a result, the abstract indications can shield user identities or other traceable information related to the users to protect user privacy. In other embodiments, the optional abstract indication component 126 may be omitted, and the user information 130 may not include any abstract indications.

In operation, the input/output component 108 of the server 102 receives the user information 130 from the user device 120 via the computer network 140. In response, the database component 106 retrieves records of the electronic messages 112, and the message component 104 of the server 102 selects a set of electronic messages 112 based on the received user information 130.

The message component 104 can also append meta data to the generated set of electronic messages 112 as described above. For example, the appended meta data may indicate that a first electronic message (e.g., an advertisement) has a five-dollar bid for an impression if a number of people in audience is less than two. However, the bid is increased to ten dollars for an impression if the number of people in audience is equal or greater than two. The appended meta data may also indicate that a second electronic message has a seven-dollar bid for an impression without increases based on the number of people in audience.

The input/output component 108 of the server 102 can then transmit the generated set of electronic messages 112 with the appended meta data to the user device 120 via the computer network 140. The device filter 124 of the user device 120 then filters the set of electronic messages 112 received from the server 102 based on the user data 127 in the device database 125 and select a subset of the electronic messages 112 for output via the device interface 122.

In the example above, if the user data 127 indicate that there is only one person in the audience, then the device filter 124 selects the second electronic message over the first electronic message because the bid price of the second electronic message (i.e., seven dollars) is higher than that of the first electronic message (i.e., five dollars). On the other hand, if the user data 127 indicate that there are three people in the audience, then the device filter 124 selects the first electronic message over the second electronic message because the bid price of the second electronic message (i.e., seven dollars) is now lower than that of the first electronic message (i.e., ten dollars).

In another example, the device filter 124 can also filter the set of electronic messages 112 received from the server 102 based on a travel direction of the user device 120. As a result, the selected subset of electronic messages 112 can include electronic messages that are related to products and/or services available at locations generally in the travel direction of the user device 120. Thus, the selected subset of electronic messages 112 can be more useful to a user than other electronic messages because the user is presumably less likely to visit locations that are not in the travel direction.

The device filter 124 can then transmit the impression indicator 136 to identify the output subset of electronic messages 112 to the server 102. As such, several embodiments of the present technology can protect user privacy while providing more relevant, useful, and/or suitable electronic messages than conventional techniques. User privacy is protected because private and/or sensitive user information contained in the user data 127 is not transmitted to the server 102 via the computer network 140. Meanwhile, more relevant, useful, and/or suitable electronic messages may be generated than conventional techniques because the present technology utilizes information (i.e., the user data 127) not available to the server 102 to select the subset of electronic messages 112 output via the device interface 122. In addition, processing and/or transmission capacity of the user device 120 and/or the computer network 140 may be conserved by not transmitting the user data 127 to the server 102.

FIG. 2 is a block diagram showing software modules suitable for the device filter 124 of FIG. 1 in accordance with embodiments of the present technology. As shown in FIG. 2, the device filter 124 can include an input module 160, an analysis module 162, a control module 164, and a calculation module 166 interconnected with one another. Each module may be a computer program, procedure, or routine written as source code or intermediate code in a conventional programming language, or may be hardware modules.

The input module 160 is configured to receive the set of electronic messages 112 from the server 102 (FIG. 1) and the user data 127 (e.g., the sensor signal 134 from the optional sensor 128 in FIG. 1). The input module 160 can also normalize, sort, filter, remove, interpolate, extrapolate, and/or otherwise manipulate the received electronic messages 112 and/or the user data 127 for further processing. For example, in one embodiment, the input module 160 may convert the sensor signal 134 into a suitable value. The value can represent at least one of a number of people in audience, a travel direction of the user device 120 (FIG. 1), and/or other suitable data.

The calculation module 166 may include routines configured to perform various types of calculations to facilitate operation of other modules. For example, the calculation module 166 may include counters, timers, and/or other suitable accumulation routines for deriving a standard deviation, variance, root mean square, and/or other metrics of the received sensor signal 134. For example, the calculation module 166 may be configured to filter noises from a calculated travel direction by monitoring a change in the calculated travel direction based on a preset threshold. If the change in travel direction is above the threshold, the calculated travel direction may be removed as noise.

The analysis module 162 may be configured to filter the received set of electronic messages 112 based on the user data 127. For example, the analysis module 162 can be configured to select a subset of electronic messages 112 (e.g., advertisements) that has higher bid prices for impressions than another subset of electronic messages 112. In another example, the analysis module 162 can be configured to select a subset of electronic messages 112 related to locations generally in a travel direction of the user device 120. In further examples, the analysis module 162 can be configured to select a subset of electronic messages 112 that are more closely related to calendar data, contact data, task data, or user activity data. For instance, if the user task data indicate an open task to inspect an air conditioning unit, the analysis module 162 can assign a higher relevance to some of the electronic messages 112 that are directed to air conditioning services, parts, manufacturers, and/or products. In certain embodiments, the analysis module 162 may also be configured to generate abstract indications based on the user data 127 without compromising user privacy, as discussed above with reference to FIG. 1.

The analysis module 162 can then supply the analysis results to the calculation module 166 and/or control module 164 for further processing. The control module 164 may be configured to generate a subset of filtered messages 138 and cause the filtered messages 138 to be output via the device interface 122 (FIG. 1). The control module 164 can also be configured to generate and transmit the impression indicator 136 identifying the filtered messages 138 to the server 102.

FIG. 3 is a flow diagram illustrating a process 200 of filtering electronic messages on a computing device in accordance with embodiments of the present technology. The process 200 is described below with reference to the computer framework 100 of FIG. 1 and the software modules of FIG. 2. For example, the computing device can be the user device 120 of FIG. 1. However, in other embodiments, the process 200 may be implemented in other suitable or other suitable types of computing device(s) capable of performing at least some of the operations of process 200.

As shown in FIG. 3, the process 200 includes an optional stage 202 at which user input may be received by the computing device. In one embodiment, the user input can include a search query input by a user into a web page of a search engine. In another embodiments, the user input can include at least one of a web page visit, gaming participation, and/or other suitable types of input. In further embodiments, optional stage 202 may be omitted.

The process 200 can include transmitting user information to a server at stage 204. In one embodiment, the server can be the server 102 of FIG. 1. In other embodiments, the server can also include a web server, a data server, and/or other suitable servers. In one embodiment, the user information can include search queries and/or inferred information from the search queries. For example, the inferred information may include geographic locations from which the search queries originated, profile information (e.g., age, gender, etc.) of users associated with the search queries, prior search histories, and/or other types of information. In other embodiments, the user information can include browser histories, gaming activity information, data related to opening/closing of applications, download histories, and/or other suitable data.

As shown in FIG. 3, the process 200 can optionally include generating and transmitting an abstract indication to the server at stage 205. In one embodiment, the abstract indication can be generated based on the user data on the computing device without compromising user privacy, as described above with reference to FIG. 1. For example, the abstract indication may include a generic description of user activities. In other embodiments, the abstract indication may be generated by correlating the user activities to a predefined list. In further embodiments, optional stage 205 may be omitted.

The process 200 can include receiving a set of electronic messages from the server in response to the transmitted user information and the optional abstract indication at stage 206. The process 200 can include filtering the received electronic messages based on the user data on the computing device at stage 208. In one embodiment, filtering the received electronic messages can include selecting a subset of the received electronic messages based on the user data, as described above with reference to FIGS. 1 and 2. In one example, the received electronic messages may include 500 electronic messages, and the subset of the electronic messages may include only 50 electronic messages. In other examples, the received electronic messages and/or the subset of electronic messages may include other suitable numbers of electronic messages. The selected subset of electronic messages can then be output to the computing device and/or other suitable output devices. The computing device can also indicate the selected subset of electronic messages to the server.

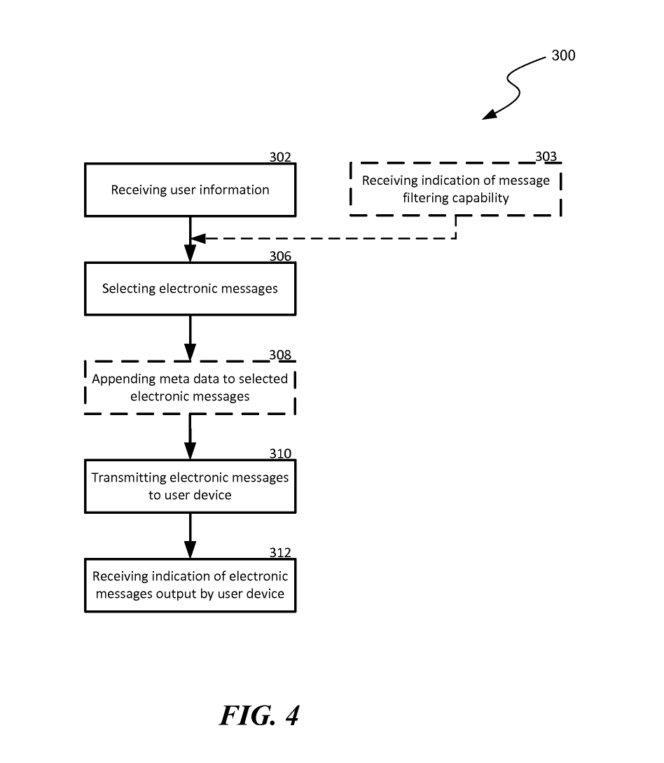

FIG. 4 is a flow diagram illustrating a process 300 of providing electronic messages in accordance with embodiments of the present technology. The operations of the process 300 may be performed by, for example, the server 102 of FIG. 1 and/or other suitable servers or services. As shown in FIG. 4, the process 300 includes receiving user information at stage 302 and optionally receiving an indication of message filtering capability on a user device at stage 303. The user information can include various user input, inferred data from user input, user activity data, and/or other suitable types of information, as described above with reference to FIG. 1. The indication of message filtering capability can include a serial number, a flag, a device number, and/or other information identifying the user device.

The process 300 can then include selecting a set of electronic messages based on the received user information and the optional indication of message filtering capability at stage 306. In one embodiment, if the indication of message filtering capability is received, the selected set of electronic messages may have a first number of items; otherwise, the selected set of electronic messages may have a second number of items less than the first number.

Optionally, in certain embodiments, the process 300 can include appending meta data to the selected set of electronic messages at stage 308. The appended meta data can include any suitable data describing the individual electronic messages, for example, as those described above with reference to FIG. 1. In other embodiments, the operation at stage 308 may be omitted, and the selected set of electronic messages may or may not include previously appended meta data. The process 300 then includes transmitting the selected set of electronic messages with the appended meta data to the user device at stage 310 via, for example, the computer network 140 of FIG. 1. As discussed above with reference to FIGS. 1-3, the user device may then filter the received set of electronic messages based on user data on the user device. The process 300 can then include receiving an indication of a subset of the transmitted electronic messages that are actually output by the user device at stage 312.

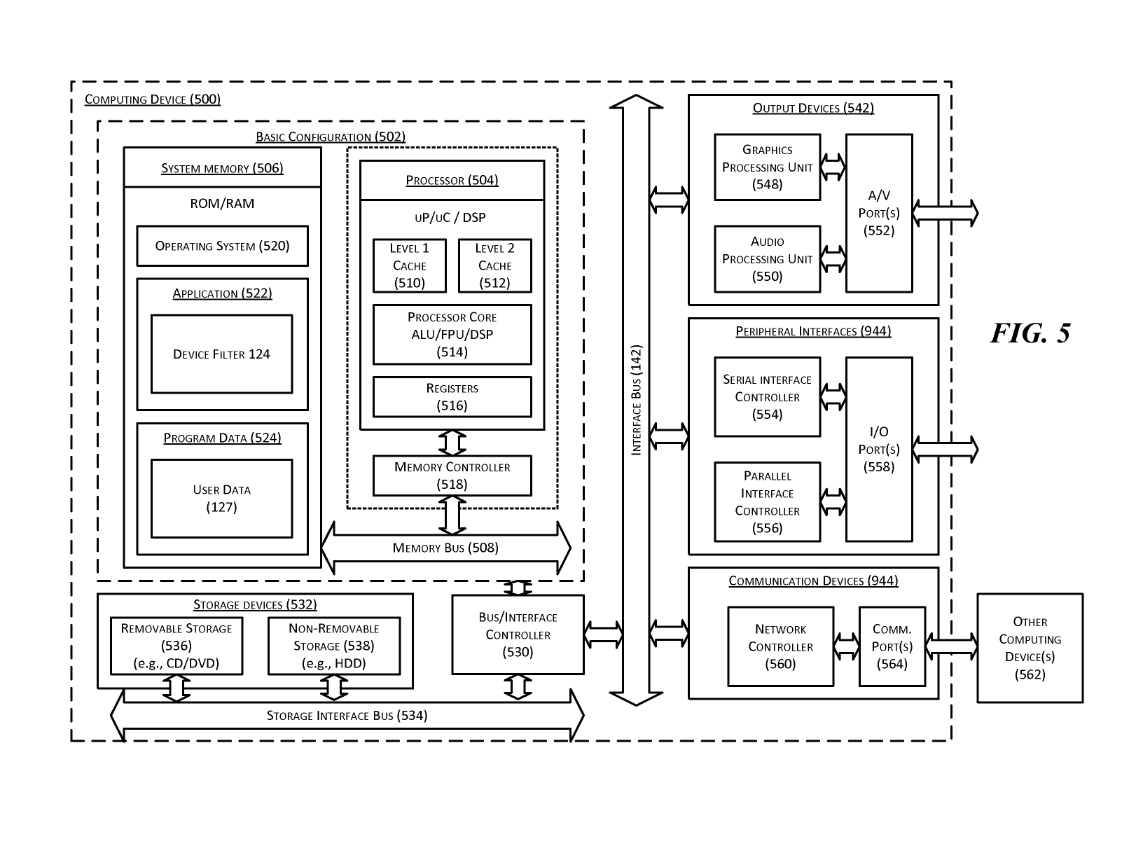

FIG. 5 is a computing device 500 suitable for certain components of the computer framework 100 in FIG. 1. For example, the computer device 500 may be suitable for the server 102 or the user device 120 of FIG. 1. In a very basic configuration 502, computing device 500 typically includes one or more processors 504 and a system memory 506. A memory bus 508 may be used for communicating between processor 504 and system memory 506.

Depending on the desired configuration, the processor 504 may be of any type including but not limited to a microprocessor (μP), a microcontroller (μC), a digital signal processor (DSP), or any combination thereof. The processor 504 may include one more levels of caching, such as a level one cache 510 and a level two cache 512, a processor core 514, and registers 516. An example processor core 514 may include an arithmetic logic unit (ALU), a floating point unit (FPU), a digital signal processing core (DSP Core), or any combination thereof. An example memory controller 518 may also be used with processor 504, or in some implementations memory controller 518 may be an internal part of processor 504.

Depending on the desired configuration, the system memory 506 may be of any type including but not limited to volatile memory (such as RAM), non-volatile memory (such as ROM, flash memory, etc.) or any combination thereof. The system memory 506 may include an operating system 520, one or more applications 522, and program data 524. The application 522 may include, for example, the device filter 124 of the user device 120 (FIG. 1). The program data 524 may include, for example, the user data 127 as is described herein. In some embodiments, the application 522 may be arranged to operate with program data 524 on operating system 520. This described basic configuration 502 is illustrated in FIG. 5 by those components within the inner dashed line.

The computing device 500 may have additional features or functionality, and additional interfaces to facilitate communications between basic configuration 502 and any other devices and interfaces. For example, a bus/interface controller 530 may be used to facilitate communications between the basic configuration 502 and one or more data storage devices 532 via a storage interface bus 534. The data storage devices 532 may be removable storage devices 536, non-removable storage devices 538, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 506, removable storage devices 536 and non-removable storage devices 538 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 500. Any such computer storage media may be part of computing device 500. The term “computer storage medium” excludes propagated signals and communication media.

The computing device 500 may also include an interface bus 540 for facilitating communication from various interface devices (e.g., output devices 542, peripheral interfaces 544, and communication devices 546) to the basic configuration 502 via bus/interface controller 530. Example output devices 542 include a graphics processing unit 548 and an audio processing unit 550, which may be configured to communicate to various external devices such as a display or speakers via one or more A/V ports 552. Example peripheral interfaces 544 include a serial interface controller 554 or a parallel interface controller 556, which may be configured to communicate with external devices such as input devices (e.g., keyboard, mouse, pen, voice input device, touch input device, etc.) or other peripheral devices (e.g., printer, scanner, etc.) via one or more I/O ports 558. An example communication device 546 includes a network controller 560, which may be arranged to facilitate communications with one or more other computing devices 562 over a network communication link via one or more communication ports 564.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 500 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. The computing device 500 may also be implemented as a personal computer including both laptop computer and non-laptop computer configurations.

Specific embodiments of the technology have been described above for purposes of illustration. However, various modifications may be made without deviating from the foregoing disclosure. In addition, many of the elements of one embodiment may be combined with other embodiments in addition to or in lieu of the elements of the other embodiments. Accordingly, the technology is not limited except as by the appended claims.

I/We claim:

1. A method performed by a processor of a user device, the method comprising:
receiving a search query;
transmitting the received search query to a server;
receiving a set of electronic messages from the server in response to the transmitted search query;
selecting a subset of the received electronic messages based on user data residing on the user device; and
displaying the selected subset of the electronic messages.

2. The method of claim 1 wherein the user data include at least one of calendar data, contact data, task data, user activity data, or sensor data residing on the user device, and wherein transmitting the received search query includes transmitting the received search query to the server without transmitting the user data.

3. The method of claim 1, further comprising identifying to the server the subset of the received electronic messages displayed at the user device.

4. The method of claim 1 wherein the user device includes a sensor operatively coupled to the processor, the sensor including at least one of a motion sensor, an infrared sensor, a proximity sensor, an accelerometer, an ambient light sensor, a moisture sensor, or a gyroscope, and wherein the method further includes:
receiving an input from the sensor; and
generating at least a portion of the user data based on the received input from the sensor.

5. The method of claim 5 wherein:
the received electronic messages include advertisements individually include multiple bid prices; and
selecting the subset of the received electronic messages includes selecting a subset of the received advertisements individually having a higher bid price than other advertisements based on one or more values of the user data on the user device.

6. The method of claim 1 wherein the user device includes a sensor operatively coupled to the processor, the sensor being configured to detect a number of people proximate the user device, and wherein the method further includes:
receiving an input from the sensor;
determining the number of people proximate the user device based on the received input from the sensor; and
wherein selecting the subset of the received electronic messages includes selecting a first subset of the received electronic messages in response to the determined number of people being greater than a preset threshold; otherwise, selecting a second subset different than the first subset.

7. The method of claim 6 wherein:
the received set of electronic messages include advertisements individually include multiple bid prices individually corresponding to a number of people viewing the individual advertisements; and
selecting the subset of the received electronic messages includes selecting a subset of the received advertisements individually having a higher bid price than other advertisements based on the determined number of people proximate the user device.

8. The method of claim 1 wherein the user device includes a sensor operatively coupled to the processor, the sensor being configured to detect a travel direction of the user device, and wherein the method further includes:
receiving an input from the sensor;
determining the travel direction of the user device based on the received input from the sensor; and
wherein selecting the subset of the received electronic messages includes selecting a subset of the electronic messages associated with a direction generally aligned with the determined travel direction of the user device.

9. The method of claim 1, further comprising:
converting the user data into an abstract indication configured to signal a condition associated with the user device, the condition including at least one of a user activity, a number of people proximate the user device, or a travel direction of the user device;
wherein transmitting the received search query includes transmitting the received search query along with the abstract indication to the server; and
wherein receiving the set of electronic messages includes receiving a set of electronic messages from the server in response to both the transmitted search query and the abstract indication.

10. The method of claim 1 wherein:
transmitting the received search query includes indicating to the server a capability to select a subset of the received electronic messages by the user device before displaying the selected subset of the electronic messages; and
receiving the set of electronic messages includes receiving a set of electronic messages from the server in response to the transmitted search query and the indicated capability to select a subset of the received electronic messages by the user device before displaying the selected subset of the electronic messages.

11. A computer system having a processor and a memory containing instructions that when executed by the processor, causing the processor to perform a process comprising:
receiving a search query from a user device;
selecting a set of electronic messages in response to the received search query;
transmitting the selected set of electronic messages to the user device; and
receiving an indication from the user device, the indication identifying a subset of the transmitted electronic messages displayed by the user device.

12. The computer system of claim 11 wherein the set of electronic messages include a set of advertisements, and wherein selecting the set of electronic messages further includes appending meta data to the selected set of advertisements, the meta data describing multiple bid prices of the individual advertisements based on one or more values of user data on the user device.

13. The computer system of claim 11 wherein the process further includes:
determining whether an indicator from the user device is received, the indicator indicating a capability of the user device to select a subset of the transmitted electronic messages before displaying the selected subset of the electronic messages at the user device;
in response to receiving the indicator, selecting a set of electronic messages with a first number of electronic messages; and
in response to absence of the indicator, selecting a set of electronic messages with a second number of electronic messages, the second number being less than the first number.

14. The computer system of claim 11 wherein the process further includes:
receiving an abstract indication from the user device, the abstract indication being based on the user data on the user device and configured to indicate a condition associated with the user device; and
wherein selecting the set of electronic messages includes selecting a set of electronic messages in response to both the received search query and the abstract indication.

15. The computer system of claim 11 wherein the process further includes:
receiving an abstract indication from the user device, the abstract indication being based on the user data on the user device and includes a signal representing at least one of a user activity, a user preference, or a user profile; and
wherein selecting the set of electronic messages includes selecting a set of electronic messages in response to both the received search query and the abstract indication.

16. The computer system of claim 11 wherein the process further includes:
receiving an abstract indication from the user device, the abstract indication being based on the user data on the user device and includes a signal representing at least one of a user activity, a user preference, or a user profile without user identifying information; and
wherein selecting the set of electronic messages includes selecting a set of electronic messages in response to both the received search query and the abstract indication.

17. A computing device having a processor, a memory, and a sensor operatively coupled to one another, the memory containing instructions that, when executed by the processor, causing the processor to perform a process comprising:
receiving an input from the sensor;
generating sensor data based on the received input from the sensor;
receiving a search query;
transmitting the received search query to a server without transmitting the sensor data;
receiving a set of electronic messages from the server in response to the transmitted search query, the received set of electronic messages individually having appended meta data describing selection of the electronic messages based on one or more values of the sensor data on the computing device;
filtering the received set of electronic messages to select a subset of the received electronic messages in accordance with the appended meta data based on one or more values of the generated sensor data; and
displaying the generated subset of the electronic messages.

18. The computing device of claim 17 wherein the process further includes:
converting the user data into an abstract indication configured to signal a condition associated with the computing device, the condition including at least one of a user activity, a number of people proximate the user device, or a travel direction of the user device;
wherein transmitting the received search query includes transmitting the received search query along with the abstract indication to the server; and
wherein receiving the set of electronic messages includes receiving a set of electronic messages from the server in response to both the transmitted search query and the abstract indication.

19. The computing device of claim 17 wherein the process further includes indicating to the server a capability to select a subset of the received electronic messages by the computing device before displaying the subset of the electronic messages.

20. The computing device of claim 17 wherein the process further includes transmitting an indication to the server to identify the displayed subset of the received electronic messages.
